(19) United States
(12) Patent Application Publication
(10) Pub. No.: US 2002/0154357 A1
(43) Pub. Date: Oct. 24, 2002

(54) Methods and apparatus for reconfigurable WDM lightpath rings

(76) Inventors: Cuneyt Ozveren, Saratoga, CA (US); Stephen J. Shaffer, Alameda, CA (US); Parayath Gopal K. Menon, Fremont, CA (US); Mark Lowry, Castro Valley, CA (US)

Correspondence Address: WILSON SONSINI GOODRICH & ROSATI, 650 PAGE MILL ROAD, PALO ALTO, CA, 943041050

(21) Appl. No.: 10/112,091

(22) Filed: Mar. 29, 2002

Related U.S. Application Data
(60) Provisional application No. 60/280,550, filed on Mar. 29, 2001.
(60) Provisional application No. 60/280,347, filed on Mar. 29, 2001.

(51) Int. Cl. H04B 10/20; H04J 14/00; H04J 14/02

(52) U.S. Cl. 359/124; 359/119

(57) ABSTRACT

Methods and apparatus for dynamic bandwidth provisioning in wavelength division multiplexing (WDM) optical ring networks. A plurality of nodes within the network are configured to transmit optical signals at variable wavelengths and receive optical signals at a predetermined wavelength. A network management system computer may be provided to communicate with the network nodes to direct the wavelengths at which each node transmits and receives. A series of one or more lightpath rings within the network are defined by selecting a first plurality of network nodes to provide a channel to support the optical transmission of a communication signal therebetween having a first bandwidth allocation. Each network node within the first plurality of network nodes is instructed upon command by the network management system to transmit an optical signal at a predetermined wavelength that is to be received by only one other network node within the first plurality of network nodes to form a first series of optical links therebetween which in the aggregate form the lightpath ring. Each network node within the second plurality of network nodes is instructed upon command by the network management system to transmit an optical signal at a predetermined wavelength that is to be received by only one other network node within the second plurality of network nodes to form a second series of optical links therebetween which in the aggregate reforms the lightpath ring. Accordingly, the lightpath ring may be reformed upon command by the network management system by altering the number of network nodes within the first plurality of network nodes to define a second plurality of network nodes which dynamically provides the channel with a different bandwidth allocation.

### CROSS-REFERENCE TO RELATED APPLICATIONS

This application claims the benefit of the United States provisional patent application Serial No. 60/280,550 filed on Mar. 29, 2001 which is incorporated by reference herein its entirety. Additionally this application is related to copending U.S. patent application Ser. No. ______, filed concurrently herewith entitled “Open Ring Architectures for Optical WDM Networks” claiming the benefit of the United States provisional patent application Serial No. 60/280,347, which are both incorporated by reference herein in their entirety.

### FIELD OF THE INVENTION

The invention relates to optical network communication systems. More particularly, the invention relates to bandwidth provisioning in wavelength division multiplexing optical networks and related optical network components.

### BACKGROUND

Optical networks offer the potential for extremely high point-to-point bandwidth. While this potential benefit has been recognized for several decades, there are currently insufficient means to dynamically provision bandwidth to end users or subnets. Bandwidth provisioning and allocation is important to the economical use of current and future optical technologies because it offers a service provider the ability to efficiently use and manage available resources. Additional resources should be timely allocated to those end users and portions of an optical network with the highest demand. Current bandwidth provisioning solutions are generally inefficient and impractical. The bandwidth allocation or provisioning of today is often accomplished manually by deploying technicians in the field who actually travel to physical locations along network nodes to arrange fiber patch-panels. This process is both time-consuming and relatively expensive. These and other problems associated with bandwidth allocation identified herein have not been directly addressed by others in the field of optical networks.

A general description of the operation and design of well known optical network systems are illustrated in the following patents which are incorporated by reference with their cited references as if entirely restated herein: U.S. Pat. No. 5,093,743 entitled Optical Packet Switch wherein an interconnect fabric from a plurality of fixed wavelength transmitters that are used to transmit arriving data packets through a star coupler, and a plurality of tunable receivers which tune to whatever frequency necessary to receive the desired data from the star coupler. A control network is also described that is constructed from a plurality of fixed wavelength receivers and a plurality of tunable transmitters that determines what frequencies the tunable receivers should tune to, and sends a signal to effectuate such tuning; U.S. Pat. No. 5,101,290 entitled High-Performance Packet-Switched WDM Ring Networks With Tunable Lasers wherein a communications network comprises subnetworks multiplexed onto a single communications medium. A separate group of NIU's communicate on each predetermined subnetwork, and each NIU also includes a tunable transmitter for transmitting data to NIU's of other subnetworks. Data from a user equipment is transmitted via the tunable transmitter if it is destined for an NIU from another subnetwork, and via a fixed transmitter if it is destined for an NIU on the same subnetwork; U.S. Pat. No. 5,452,115 entitled Communications System wherein a communication system comprises a wavelength multiplexing network having a plurality of transmission channels of different wavelengths and a plurality of nodes interconnected by the wavelength multiplexing network for performing data communications with other nodes using time slots into which time on each of the transmission channels is divided. Each of the nodes has its transmitting wavelength fixed and unique to a node and its receiving wavelength set tunable. A network controller is provided for centrally controlling time slot allocation repeated for each frame to the nodes; and U.S. Pat. No. 5,917,623 entitled Wavelength Division Multiplexing Systems wherein a wavelength division multiplexing system includes a first optical output level detector for detecting an optical output level of a first signal light transmitted on a transmission line, a signal light transmitter for transmitting an additional signal light to be multiplexed with the first signal light, and an optical coupler for multiplexing the additional signal light with the first signal light.

### BRIEF SUMMARY OF THE INVENTION

The invention described herein provides dynamic bandwidth allocation for optical networks. Wavelength division multiplexing optical networks may be constructed or modified in accordance with the invention to provide reconfigurable lightpath rings that allocate network bandwidth on a dynamic basis. It shall be understood that all aspects of the invention may be applied to any type of optical network within applicable parameters. The particular features of the described embodiments in the following specification may be considered individually or in combination with other variations and aspects of the invention.

An object of the invention is to provide Methods and Apparatus for dynamic bandwidth provisioning in wavelength division multiplexing (WDM) optical ring networks. A plurality of nodes within the network are configured to transmit optical signals at variable wavelengths and receive optical signals at a predetermined wavelength. A network management system computer may be provided to communicate with the network nodes to direct the wavelengths at which each node transmits and receives. A series of one or more lightpath rings within the network are defined by selecting a first plurality of network nodes to provide a channel to support the optical transmission of a communication signal therebetween having a first bandwidth allocation. Each network node within the first plurality of network nodes is instructed upon command by the network management system to transmit an optical signal at a predetermined wavelength that is to be received by only one other network node within the first plurality of network nodes to form a first series of optical links therebetween which in the aggregate form the lightpath ring. Each network node within the second plurality of network nodes is instructed upon command by the network management system to transmit an optical signal at a predetermined wavelength that is to be received by only one other network node within the second plurality of network nodes to form a second series of optical links therebetween which in the aggregate reforms the lightpath ring. Accordingly, the lightpath ring may be reformed upon command by the network management system by altering the number of network nodes within the first plurality of network nodes to define a second plurality of network nodes to dynamically provide the channel with a second bandwidth allocation.

Another embodiment of the invention provides a reconfigurable optical network with dynamic bandwidth allocation. The network includes a plurality of network nodes wherein each node includes a receiver (Rx) configured to receive optical signals at a predetermined wavelength specific for such node and a tunable transmitter (Tx) configured to transmit optical signals at variable wavelengths. A network management system computer and related control software is further provided for provisioning bandwidth. The network management system is in communication with each network node across a control network and forms reconfigurable lightpath rings as between a plurality of nodes within the network to provide an optical communication channel therebetween having a provisioned bandwidth. The tunable transmitter (Tx) at each network node within the lightpath ring is directed by the network management system to transmit an optical signal at the predefined wavelength corresponding to the receiver (Rx) of only one other node within the lightpath ring to form an optical link therebetween. A plurality of optical links in the aggregate form the reconfigurable lightpath ring to support transmission of the optical signal at the provisioned bandwidth. The provisioned bandwidth may be altered by changing the membership or number of nodes within the lightpath ring on-command by the network management system which may be in response to network customer requests for more or less bandwidth.

It is a further object of the invention to provide bandwidth allocation methods and apparatus that builds upon SONET ring technologies or that is generally applicable to all shared-bandwidth rings. Furthermore, the embodiments of the invention described herein scale gracefully and economically, independent of data modulation rates. The bandwidth allocation provided herein may be achieved at the optical layer requiring no electrical switching which often adds an added level of complexity and is more expensive relatively at high-speed line rates. Because various embodiments of the invention can scale to relatively high-speed reconfigurations, it can also be used for network traffic engineering purposes and provide bandwidth reallocation in response to rapidly varying demands and traffic loads.

Yet another object of the invention is to provide various add drop multiplexing components and configurations that may be incorporated into other optical network embodiments formed in accordance with the invention.

Other objects and advantages of the invention will become apparent upon further consideration of the specification and drawings. While the following description may contain many specific details describing particular embodiments of the invention, this should not be construed as limitations to the scope of the invention, but rather as an exemplification of preferable embodiments. For each aspect of the invention, many variations are possible as suggested herein that are known to those of ordinary skill in the art.

### BRIEF DESCRIPTION OF THE DRAWINGS

FIG. 1 is a topological illustration of a wavelength division multiplexing (WDM) optical network consisting of a plurality of nodes that are linked together to form configurable lightpath rings that provide network bandwidth provisioning in accordance with the invention.

FIG. 2 is a table describing various signal wavelengths passing between the network nodes that form the lightpath rings in FIG. 1.

FIG. 3 is an illustration of a network management system that manages network bandwidth and lightpath ring formation and reformation in accordance with the invention.

FIGS. 4 and 5 describe the WDM optical network upon reconfiguration of the lightpath rings.

FIGS. 6 and 7 describe a network configuration with multiple management network centers and intersecting lightpath rings.

FIG. 8 describes another embodiment of the invention that incorporates tunable receivers and transmitters in lightpath rings which communicate at preselected wavelengths.

FIG. 9 is a simplified illustration of an add-drop multiplexer (ADM) that may be selected at network nodes which form the lightpath rings in accordance with the invention.

FIG. 10 describes a tunable add element that may selected for the ADMs described herein.

FIG. 11 describes a tunable drop element that may selected for the ADMs described herein.

FIG. 12 is a simplified diagram of an add-drop multiplexer that may be installed at a network node with a predefined fixed wavelength receiver.

FIG. 13 is an illustration of another ADM that may be selected for the optical networks herein to provide reconfigurable lightpath rings.

FIG. 14 is yet another diagram of an ADM with a 3-port thin-film filter configured for receiving optical signals at a predetermined wavelength.

FIG. 15 is a table describing an optical network that is provisioned in accordance with another embodiment of the invention having configurable lightpath rings that re-use selected wavelengths.

### DETAILED DESCRIPTION OF THE INVENTION

FIG. 1 illustrates a wavelength division multiplexing (WDM) optical ring network that may be configured in accordance with the invention. The WDM networks described herein incorporate the fundamental operation and known principles of wavelength division multiplexing. It shall be understood that all embodiments of the invention are particularly applicable for dense WDM (DWDM) networks, but are equally applicable to any other ring or optical network.

As shown in FIG. 1, the dynamically configurable WDM optical network consists of fifteen network nodes, Nodes 1 through 15, respectively, and a metropolitan network center (MNC). A “physical link” is formed as between the network nodes which are linked together with fiber optic connections and optical fiber. Multiple signals at different wavelengths may be transmitted and travel along a common fiber or multiple optical fibers in a predetermined optical transmission direction. Each node within the network may be therefore physically connected to adjacent network peer nodes to form a continuous ring network as illustrated. In addition, various network nodes may be grouped together to form communication channels there between so that members of each group share a “logical link” between other group members. These optical communication channels may be also construed as or referred to herein as lightpath rings. Multiple network nodes may be logically connected to others in order to form a plurality of different groups and lightpath rings. For example, the optical ring network in FIG. 1 is configured to provide five different and distinct lightpath rings or communication channels, Lightpath Rings A through E. Lightpath Ring A may consist of links between network nodes 1, 2, 3 and the MNC, Lightpath Ring B may consist of links between nodes 4, 5, 6 and the MNC, Lightpath Ring C may consist of links between nodes 7, 8, 9 and the MNC, Lightpath Ring D may consist of links between 10, 11, 12 and the MNC, and Lightpath Ring E may consist of links between 13, 14, 15 and the MNC. It shall be understood that the membership of these groups of nodes may be altered to provide configurable lightpath rings, and that the network nodes and lightpath rings described above is for illustrative purposes. The total number of nodes and lightpath rings may be varied in accordance with the invention to dynamically provide network bandwidth management as described herein.

Each network node shown in FIG. 1 may be configured to receive optical signals or light transmissions at a fixed and unique wavelength. An optical receiver at each node may receive intended optical signals transmitted from another member in the network, or more specifically, from another member of its respective lightpath ring. Other embodiments of the invention described herein also include tunable wavelength drops or receivers at network nodes to receive variable wavelengths and are not limited to fixed receivers only. At the same time, each node may include a tunable optical transmitter to transmit light signals at various wavelengths depending upon which ring member is intended to receive the signal. For example, with respect to Lightpath Ring A, a transmitter at the MNC node may transmit an optical signal to Node 1 at the specific wavelength assigned to no other node except Node 1. This connection provides an optical link within the lightpath ring. In turn, Node 1 may transmit another signal at the predetermined wavelength assigned to Node 2 to be received. Node 2 may communicate with Node 3 by transmitting a light signal at another unique wavelength that is specific to Node 3, and Node 3 may subsequently establish an optical link and transmit a signal to the MNC node to complete the lightpath ring. Each lightpath ring may be formed in the aggregate by linking a plurality of optical links as between the network nodes within the defined ring. In other words, each logical ring may be also comprised of a series of logical links. Each corresponding link may have a particular wavelength (Lambdas 1-20) for a node and an actual physical link. It shall be noted that the illustrated optical network includes network nodes consisting of fifteen relatively smaller customer premises nodes (CPEs) and one relatively larger MNC or aggregation node. The MNC node may functionally constitute an additional number of CPE nodes, or individual network nodes clustered together on the network ring as shown. Each of these clustered network nodes at the MNC may be configured to receive optical signals at preselected wavelengths, e.g. Lambdas 16-20. Additionally, the number of CPE nodes shown may also vary, and each may in turn be considered the functional equivalent of multiple network nodes. The number of CPE nodes (within the MNC) typically equals the number of logical rings that may be instantiated within the described configurable networks for this configuration shown in which all logical rings include the MNC.

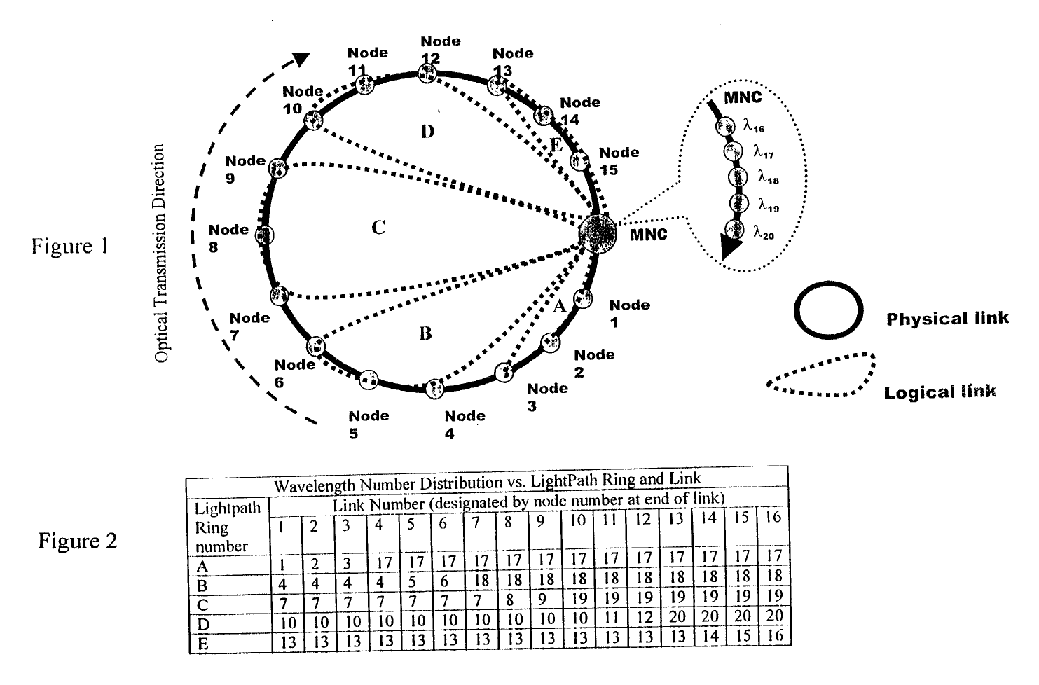

The table shown in FIG. 2 provides the various wavelengths for the optical transmissions within the optical network described above. Each configurable lightpath ring may consist of multiple light paths or segments linked together to form a single lightpath ring. Each row in the table identifies separate lightpath rings (Lightpath Rings A-E) and their corresponding sequence of optical links having different numbered wavelengths (Lambdas 1-20). For instance in the case of a C-band optical system, the available spectrum of wavelengths which may be selected herein range from 1525 nm to 1565 nm, which may provide up to forty separate 100 GHz channels or more. The number of channels can be expanded by reducing the channel spacing to 50 GHz, or even 25 GHz (thereby achieving a channel expansion of ×2 and ×4, respectively), and by including the L-band, and S-bands. Considering all potential solutions for expanding the number of wavelengths, the available wavelengths can easily scale to several hundred. Each link has a particular wavelength that is specific to intended nodes within each ring. Moreover, each column in the table lists each physical link within the ring network. Since the ring network described above includes sixteen network nodes, including the aggregation node, there are sixteen physical links between the nodes (Link Numbers 1- 16). Each link number may be assigned a number according to the node to which the end of that link is connected. For example, the link between Node 1 and Node 2 may be designated as Link 2, the link between Node 2 and Node 3 may be designated as Link 3 and so on. The wavelength numbers within the table also correspond to a network node that is configured to uniquely receive optical transmissions sent at that particular wavelength assigned to that node. It shall be noted that the aggregate node or MNC may be selected as a common hub for all illustrated lightpath rings, and may include a plurality of optical receivers to receive light signals at multiple wavelengths. A cluster of network nodes at the MNC or common hub may be configured with receivers set to receive at Lambdas 16-20 as shown. Any other network node may also serve as a common hub for lightpath rings, or multiple common hubs or nodes may be provided depending upon network management parameters.

Optical networks may be reconfigured to provide dynamic bandwidth provisioning in accordance with the invention by controlling the number of lightpath rings and the membership of network nodes within each ring. As shown in FIGS. 1 and 2, there are five logical lightpath rings within the described optical ring network. The table in FIG. 2 identifies which wavelength (by wavelength number) is used to transmit each link for each particular lightpath ring. As can be observed for this embodiment of the invention, no wavelength is re-used within the same or any other lightpath ring within the network. In other words, multiple network nodes are not configured to receive light signals at the same wavelength as shown—each wavelength within the network is specific for a node. For example, within Lightpath Ring A, the transmitted signal from the MNC at Lambda 1 is specific to Node 1, and the wavelength of the succeeding signal at Lambda 2 is specific to Node 2. The following signal transmitted by Node 2 uniquely to Node 3 will be at Lambda 3. The final optical link which completes and forms Lightpath Ring A will be transmitted by Node 3 to the MNC at the specific wavelength Lambda 17. While Node 4 may be in fact the next adjacent node or physical neighbor, a receiver at Node 4 would not pick up signals from Node 3 in this configuration since Node 4 is configured only to receive light at Lambda 4. Similarly all other intervening nodes between Node 4 and 15 in layout shown essentially ignore the transmitted signal from Node 3 which traverses all remaining links along the fiber in the selected optical transmission direction, Link Numbers 4-16, until the signal is received by a receiver at the MNC that is configured to receive at wavelength Lambda 17.

Another lightpath ring in the configured network as shown, Lightpath Ring E, similarly contains four nodes and four corresponding wavelengths for which each node receives a signal. As with other lightpath rings in this illustration, the number of nodes within each ring may vary upon bandwidth demands as will the corresponding number of different wavelengths which constitute a lightpath ring (e.g., five nodes/five wavelengths/five optical links). With respect to Lightpath Ring E, an optical link is created at the MNC for communication with Node 13 specifically at wavelength Lambda 13. A light signal transmitted at Lambda 13 travels through all intervening nodes and optical links numbers 1-13 until it is received by Node 13. The subsequent signal sent to Node 14 at wavelength Lambda 14 is received as is the following signal for Node 15 at Lambda 15. The final optical link to complete this particular lightpath ring is established between Node 15 and the MNC at Lambda 16. The remaining lightpath rings are formed with the relevant nodes and wavelengths as set forth in the table and figure provided. It shall be further understood that any combination of one or more nodes may be selected to form one or more lightpath rings (up to fifteen 2-node lightpath rings including the MNC for the sample shown if the MNC is provisioned with fifteen nodes) as desired within established operating parameters for the network. When all logical rings within the network include the MNC as illustrated, there exists a corresponding “node” in the MNC. As a common hub for all lightpath rings, it should be noted that the MNC or any other central node may include a cluster of network nodes each having one or more optical receivers with appropriate detectors to receive a plurality of light signals at different fixed wavelengths, specifically, Lambdas 16, 17, 18, 19 and 20 as shown in the table provided. At the same time, the MNC cluster may also include a plurality of tunable laser transmitters to send signals at wavelengths specific to another node within a respective lightpath ring. The number of different optical links and unique wavelengths that are received by the MNC or aggregation node typically equals the number lightpath rings for which a network may be configured. Again there may be more than one aggregation node established at various points in the network other than at the MNC which also includes tunable transmitters and receivers configured at different wavelengths. Additionally, the overall bandwidth capacity of an optical network may also be conveniently increased at the MNC by adding additional network nodes therein to support additional lightpath rings. Rather than modifying each network node on the fiber ring to support additional bandwidth, this modification may be carried out a single location, an MNC. The maximum number of lightpath rings which may be formed within a configured network may be thus increased and can be reflected on revised lightpath ring tables.

As shown in the tables provided, continuous repetitions of a certain wavelength along the rows of the table depict or indicate light signals at those wavelengths “expressing” through the physically connected network nodes. In other words, optical signals at these wavelengths do not stop or connect to these intervening nodes, but rather pass or “express” straight through an unintended node much like an express train passing through a local train station. Moreover, in this embodiment of the invention, there is no repetition or reuse of the wavelengths within different rings. No wavelength number in the table is repeated within different ring numbers, nor is any wavelength used more than once within the same lightpath ring. Other variations of the invention further described herein provide optical networks that may reuse certain wavelengths in other logical rings which may be determined in part at least by the number of wavelengths within an available spectrum for an optical network.

The bandwidth capacity between network nodes may be modified in accordance with the invention by reconfiguring the logical pathways or lightpath rings within the network. Dynamic provisioning is thus possible to demand for end users and selected network locations. By reducing the number of nodes within a lightpath ring, the bandwidth capacity of that communication channel may be thereby increased. An increase in the number of network nodes communicating within the ring accordingly decreases available bandwidth as between those particular nodes. To provide dynamic provisioning of available network bandwidth as described herein, lightpath rings may be reformed or reconfigured on a pay-as-needed basis depending upon end user demands and predetermined subscriber arrangements. In order to satisfy end users with high bandwidth demands, the lightpath rings to which they are a member can be reconfigured to reduce the total number of network nodes within such rings. Because more network resources would be allocated for these users, a service provider would be able to satisfy such demand readily and charge more for increased capacity. When the same end users no longer require relatively high network bandwidth, the service provider may again dynamically reconfigure the optical rings within the network to increase the number of nodes within the respective rings to more equally share network resources in a cost-effective manner. The formation and reformation of network lightpath rings herein provide intelligent network bandwidth management solutions. The formation of a lightpath rings herein may generally follow two principals of ring formation: (1) the recipient node within a lightpath ring is reached by or receives a signal from its nearest logical neighbor node via transmission of an optical signal by this neighbor node at the predetermined wavelength at which the recipient node receives; and (2) collisions in lambda-space may be avoided at the logical link level when lightpath rings do not use optical links with the same wavelength. In other words, the columns within the table of FIG. 2 would not have a repeating wavelength number and no network node would include a receiver configured to receive the same fixed wavelength. For each reconfiguration of the lightpath rings within the network, a new lightpath ring table may be established in accordance with the general principals described above to illustrate dynamical provisioning and bandwidth management among network members.

Furthermore, the invention may provide dynamic provisioning in a variety of optical networks including those which follow the SONET (Synchronous Optical NETwork) protocol. SONET, or SDH (Synchronous Digital Hierarchy) as it is known in Europe, is a set of standards for interfacing optical networks. SONET is the protocol for North America and Japan, while SDH is the adopted standard for Europe. Synchronous networking is generally a concept where all the clocks driving a network are conceptually running at the same speed, which is in reality a sizable challenge. Aside from some differences in the basic frame format for each protocol, but SDH and SONET are otherwise similar and are equally applicable to the invention. SONET is based on the principal of direct synchronous multiplexing. Essentially, separate and relatively slower signals can be multiplexed directly onto and with higher speed SONET signals without intermediate stages of multiplexing. This provides numerous advanced network management and maintenance features. SONET and SDH can transport signals for most networks in existence today and have the flexibility to accommodate future networks as well as traditional telecommunications areas such as long-haul networks, local networks and loop carriers.

The formation and reformation of lightpath rings illustrated herein may be implemented to provide bandwidth provisioning using the SONET protocol in accordance with the invention. The bandwidth of a communication channel carrying SONET transmissions within an optical network may be shared and allocated among different network nodes in accordance with the invention. In general, the bandwidth available to a particular member of a lightpath ring is inversely proportional to the number of members in the ring. By decreasing the number of members or nodes within a given lightpath ring, more bandwidth is available to each member of that ring. At the same time, by increasing the number of nodes within a lightpath ring, less bandwidth is available to members of the ring. Accordingly, reconfigurable lightpaths for bandwidth re-provisioning are provided herein by removing from or adding nodes to selected lightpath rings to allocate or de-allocate (unallocate) available bandwidth to particular nodes in a SONET network. The assignment of certain wavelength number for certain nodes may be again summarized in a table format as described herein for each instance the network is configured or reconfigured to manage bandwidth allocation. However, this reconfigurable lightpath rings invention is not limited to use in SONET ring networks, but is applicable to any shared-bandwidth ring protocol.

The dynamic ring membership described herein may be achieved by using wavelength tunable lasers to retune the links which define or make up a particular ring. By re-tuning or adjusting the laser transmitters at each particular node, such node can become a member of another lightpath ring and linked to a new node by transmitting signals at the selected wavelength that is specific for the new node. By tuning or retuning the transmit wavelengths of certain nodes within a particular optical network, one may redistribute the nodes among logical rings to thereby increase or decrease the number of nodes within each logical or lightpath ring. The available bandwidth at each node within a reconfigured lightpath ring may be modified and provisioned on-demand as desired. The retuning or modification of tunable node transmitters for the optical networks described herein may be accomplished remotely through network management systems and software or other mechanisms known to those in the field. This approach may be incorporated into the overall systemwide management of network resources which may be accomplished remotely from a computer terminal, on a local area network or even across a wide area network such as the Internet. An appropriate user interface may be constructed to enable “point-and-click” provisioning of network bandwidth available to network users. With the ability to provide bandwidth on-demand in accordance with provisioning methods and apparatus described herein, service providers are able to rapidly offer new services to their existing network customers which would not be otherwise available due to bandwidth constraints.

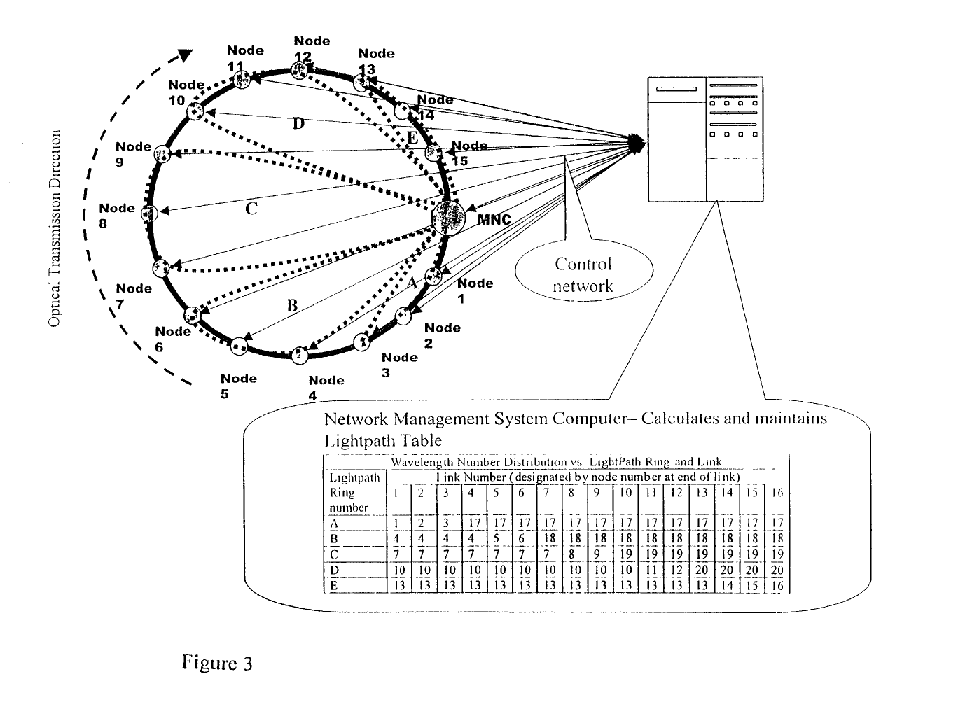

As shown in FIG. 3, a network bandwidth management system may be selected to control lightpath ring formation and network reconfiguration. A computer or series of computers may be selected to operatively manage lightpath ring formation according to existing demands and capacity. The information or data corresponding to the lightpath ring table described above may be stored in memory within or connected to a network management system (NMS) computer. The lightpath ring table may be stored on conventional computer memory devices. A controller or series of one or more microprocessors within the NMS computer may access its memory and communicate with each of the network nodes across a control network. This communication may be achieved through in-band or out-of-band (control network) means. The illustrated lines herein connecting the NMS computer with the network nodes do not necessarily imply direct physical connection, but are only meant to illustrate a logical connection which enables information flow. A separate control network as shown therefore is not required for NMS communication with network nodes. In accordance with lightpath formation data stored in memory or otherwise input, the NMS computer may instruct a resident node microprocessor responsible for one or more particular network nodes to transmit signals at a certain wavelength in order to communicate to another node within its respective lightpath ring. At the same time, if the receiver at a node is in fact tunable and not fixed, the NMS may also control the receiving frequency of a network node to dynamically allocate its network receive wavelength, effectively its network physical layer “address.” A network node computer may control transmitting, receiving and other node functions cooperatively or upon command by the NMS. Each of these inter-nodal optical links within any lightpath ring may be formed and reformed on command by the NMS computer which may initially calculate and maintain a first predetermined lightpath table, and then subsequently re-calculate and regenerate another second lightpath table for a different bandwidth provisioning scheme. The NMS computer may also look up additional table information that is stored or entered by an operator in order to configure the network in accordance with an established policy or plan. Upon a change in bandwidth demand or resources, the computer may execute network reconfiguration based on an updated table or new information input to reform previously existing lightpath rings. The NMS computer sends out the appropriate commands to the network nodes to transmit and receive light signals at selected wavelengths in accordance with a revised look up table. A new series of logical paths and lightpath rings are thus formed in the network which provides a different network bandwidth environment. The above process of reconfiguring the network to accommodate changes in bandwidth requirements and capacity may be repeated as needed to provide dynamic network provisioning.

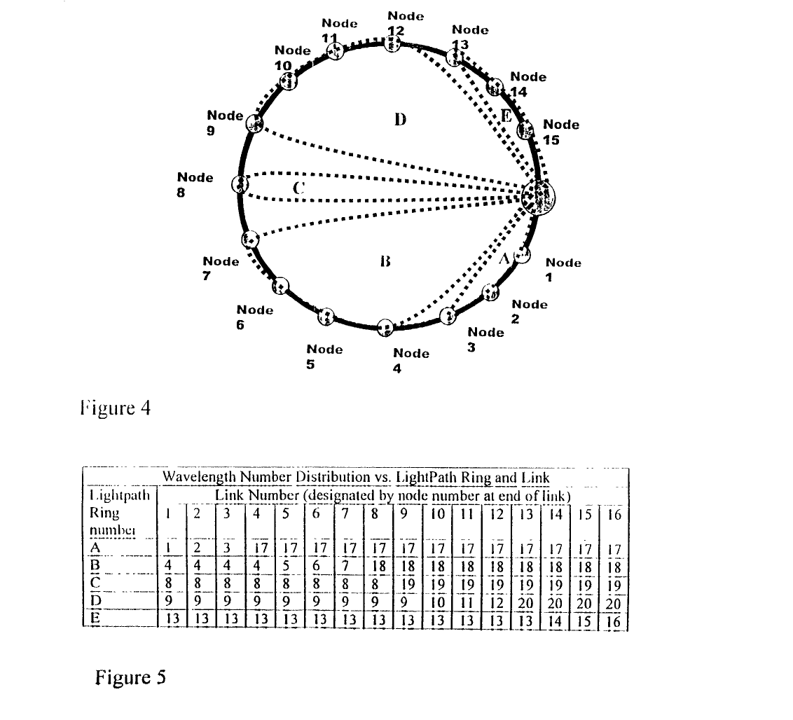

FIGS. 4 and 5 describe the reconfiguration of the optical network following a change in bandwidth allocation. It shall be observed that all lightpath ring memberships need not change upon a network reconfiguration. A select number of the lightpath rings only may be reformed as shown. While Lightpath Ring A and E remain relatively unchanged as reflected in the figure and accompanying table, the membership of Lightpath Ring B, C and E can be altered. In the particular reconfiguration shown, the node-count of logical ring or Lightpath Ring C is reduced down to only two nodes. By eliminating Nodes 7 and 9 from Lightpath Ring C, the remaining Node 8 and the corresponding network node within the MNC thus have relatively greater bandwidth as between them than before. In contrast, Node 7 is added as a member to Lightpath Ring B, and Node 9 is added as a member of Lightpath Ring D as reflected in the figure and table. The number of nodes for each respective Lightpath Ring B and D thereby increases from four members or nodes to five nodes each. As a result, the relative bandwidth availability of Nodes 7 and 9 may be thus more limited than before depending of course on the demand of other network nodes within their respective rings. A redistribution of available wavelengths can therefore occur as reflected in FIG. 5 wherein the number of assigned wavelengths within Lightpath Ring B increases to five (Lambdas 4, 5, 6, 7 and 18) as there are five nodes within that ring upon reconfiguration. There are similarly five assigned wavelengths (Lambdas 9, 10, 11, 12 and 20) within the five node ring, Lightpath Ring D. Since Lightpath Ring C now only has two nodes, only two assigned wavelengths are selected (Lambda 8 and 19). While the physical link of network nodes generally remain intact throughout the reconfiguration and lightpath reformation process, the logical links may be broken and reformed on command as described herein. It shall be understood that the reconfiguration shown is for illustrative purposes only and that the number of nodes, assigned wavelengths and lightpath ring membership may vary in accordance with the invention.

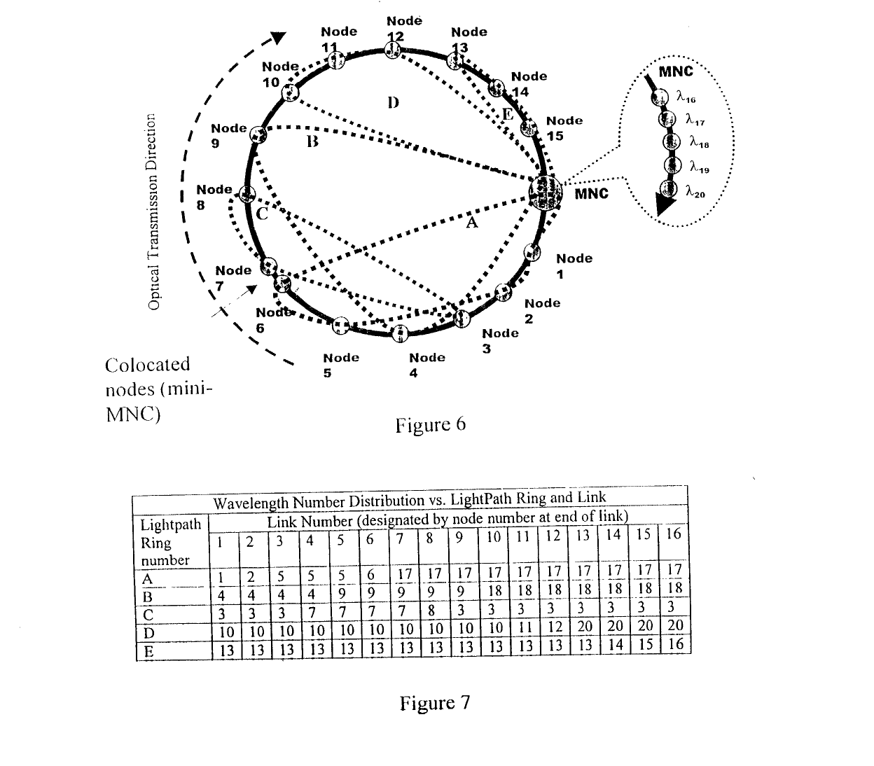

The lightpath rings formed within a configured network in accordance with the invention are not required to include a common MNC. For example, FIGS. 6 and 7 illustrate yet another embodiment of the invention that provides an optical network with lightpath rings that do not intersect at an MNC. The lightpath rings may however “cross” or intersect as a result of particular ring membership assignments as illustrated in FIG. 6. Each lightpath ring may again contain various combinations of network nodes located at various locations throughout the network. For example, Lightpath Ring A includes as its members Nodes 1, 2, 5, 6 and the MNC—a total of five nodes. Meanwhile, Lightpath Ring D (Nodes 10, 11, 12 and the MNC) and Lightpath Ring E (Nodes 13, 14, 15 and the MNC) each have four nodes, and Lightpath Ring B includes only three nodes (Nodes 4, 9 and the MNC). It shall be understood that reference to the MNC in this example in fact refers to specific group or cluster of network nodes at the MNC that include transmitters and receivers set to receive signals at assigned wavelengths, Lambdas 16, 17, 18 and 20, respectively. A “mini-MNC” at Nodes 6 and 7 may be also formed in accordance with the invention. An additional series of co-located or clustered nodes may also provide a mini-MNC so that in effect more than one metropolitan network center may exist on the network. In addition, all lightpath rings are not required to include a common node or hub. For example, Lightpath Ring C is formed between three network nodes—Nodes 3, 7 and 8. Lightpath Ring C does not include the MNC in its membership. The communication channel established between these nodes in Lightpath Ring C carries optical transmissions in the transmission direction as shown from Node 3 at wavelength Lambda 7 which is received by a receiver at Node 7, which in turn relays a signal at wavelength Lambda 8 to a receiver to Node 8, which in turn completes the ring by transmitting at Lambda 3 to communicate with a receiver located at Node 3 that is uniquely configured to receive at that wavelength. Accordingly, all lightpath rings are not required to share a common MNC.

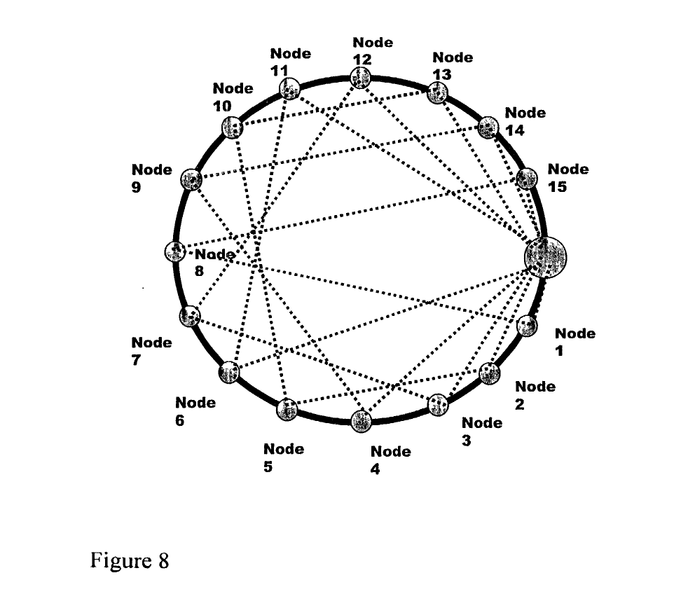

The bandwidth provisioning apparatus and methods herein may employ tunable network componentry to instantiate lightpath ring formation and reformation. As shown in FIG. 8, certain configurable WDM network rings include logical rings that are defined by using a specific predefined wavelength for both tunable transmitters and tunable receivers. Each logical ring is defined by a single predetermined wavelength. Tunable receivers may be used but are not necessary to implement network bandwidth allocation as described herein. By avoiding the required use of tunable receivers, an advantage may be recognized due to reduced costs and reduced complexity at the physical layer. Fixed receivers configured to receive optical signals at a fixed and designated wavelength also tend to drive down infrastructure and associated maintenance costs for the network. It is important to note that while some embodiments of the invention do not require the use of tunable optical filters or so-called tunable optical drop nodes, the addition of tunable filters or drops may provide yet another layer of flexibility to the configurable networks described herein. For example, as illustrated in FIG. 8, an optical ring network may include a plurality of nodes, Nodes 1-16 and the MNC. The nodes may be grouped together logically into five LambdaRings. Each LambdaRing may operate at a predetermined wavelength as to all segments within the ring. Ring membership may be thus categorized according to an assigned wavelength within an available network wavelength spectrum. Each node within each LambdaRing is configured to receive and transmit optical signals at the assigned wavelength. A signal transmission traveling in a preselected direction along the ring will only communicate with other receivers at nodes within their particular ring. As with other embodiments of the invention, the number of network nodes and LambdaRing members may vary in accordance with network management system parameters. More than one MNC may be defined also within in the network, and not all rings are required to include the MNC or a network node therein. As with other described networks herein, network nodes that are members of LambdaRings with relatively fewer nodes are provisioned with a higher available bandwidth per node. By employing both tunable receivers and tunable transmitters at nodes within the network, ring membership can be selectively modified and reformed by an NMS to provide dynamic bandwidth provisioning as described herein.

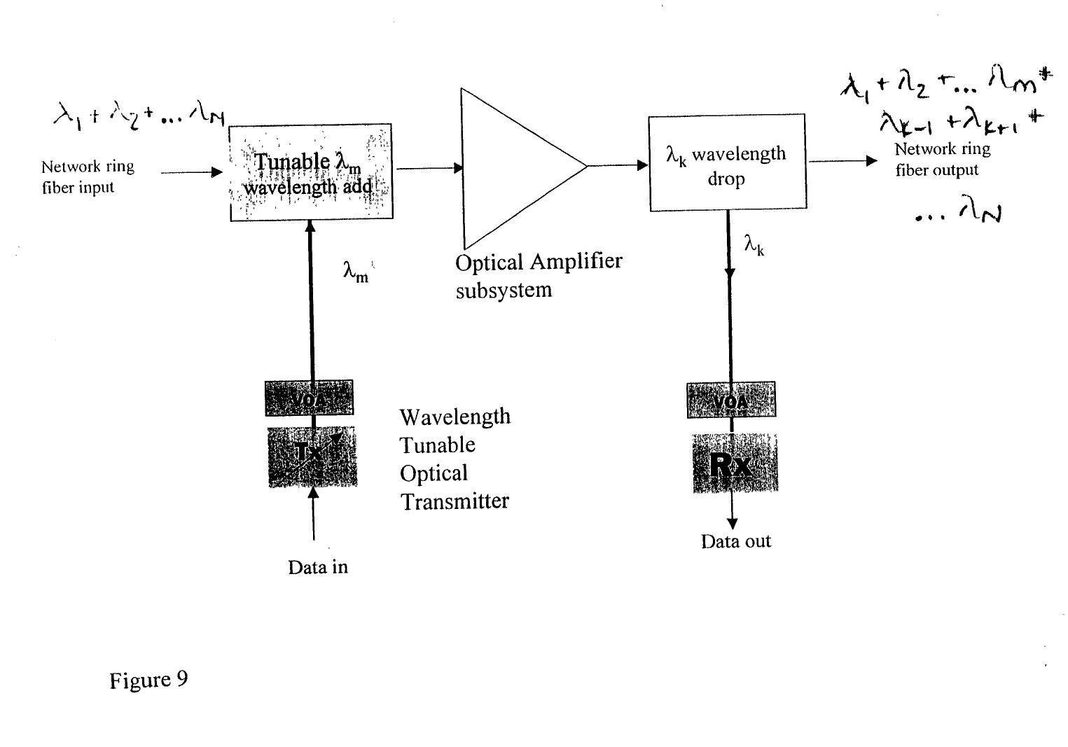

The optical ring formation and network reconfiguration apparatus and methodology described herein may be implemented with another aspect of the invention that provides optical add-drop multiplexers (ADMs) with tunable laser transmitters and fixed/tunable wavelength receivers. For example, as shown in FIG. 9, ADMs with tunable transmitters may be installed at each node for the optical ring network described above to transmit optical signals at selected bandwidths designated for certain nodes with a configured lightpath ring. An optical signal transmitted at Lambda m may be added onto an existing network data stream consisting of signals at various wavelengths, Lambdas 1-N, entering the ADM as network ring fiber input. The tunable transmitters at various network nodes are wavelength agile in order to transmit at Lambda m or any other changeable wavelength as may be instructed by an NMS or other computer depending upon selected ring formation parameters. In addition, the network node may also include a receiver fixed at a certain wavelength to receive intended signals only for that node, Lambda k. From the circulating stream of network traffic, only those signals at Lambda k are dropped at a particular designated node location. But in order to provide yet another degree of freedom in the network configuration provided herein, the drop function may be modified to receive variable wavelengths. The signal leaving the ADM as network ring fiber output may thus include the added signal at Lambda m and without the dropped signal at Lambda k. It shall be further understood that the networks node configurations described herein are shown for illustrative purposes only. The number of nodes and distinct wavelengths or optical links may be increased or decreased as desired to thus alter the maximum number of potential lightpath rings that can be supported by the network. Any of the network nodes described herein may incorporate one or more of the add/drop components described herein or those known in the field.

FIG. 9 further describes a preferable embodiment of the invention that provides ADMs configured with a tunable transmitter and a fixed receiver to receive signals at a predetermined wavelength. After a data signal transmitted at Lambda m from the wavelength tunable optical transmitter is added onto the fiber input with a suitable add element, the signal may be amplified by an optical amplifier subsystem or amplifier component before passing through the drop element of the ADM. The wavelength drop element drops the signal transmitted at Lambda k, the assigned wavelength for the node. It shall be observed that in this embodiment of the invention, an incoming data signal transmitted at Lambda m is added onto the fiber traffic and amplified by an intermediary amplifier before an outgoing data signal to the node at Lambda k is dropped from the fiber traffic to the node. Furthermore, a variable optical attenuator (VOA) may be placed in front of the respective paths of light signals leading to the transmitter and the receiver as shown. The VOA provides an ability to adjust the optical power launched onto the fiber segment leading to the receiver which in turn allows for compensation of the spectrally non-uniform gain of amplifiers such as an erbium-doped fiber amplifier (EDFA) which may be selected with the ADMs herein. When selected for these types of applications, VOAs may allow different channels to be presented with nearly equal input powers to the EDFA which allows for the efficient use of the resulting EDFA gain. At the same time, the VOA for the receiver may be also used to extend its dynamic range which can increase network scalability. This configuration as shown may minimize the impact of amplified stimulated emission (ASE) noise on signal quality from neighboring EDFAs which are used for loss compensation of optical signals. The illustrated sequence however as between the add element, the amplifier and the drop element, may also be rearranged in accordance with the invention. It shall be understood that VOAs may also not be required in certain applications for either the node transmitter or receiver.

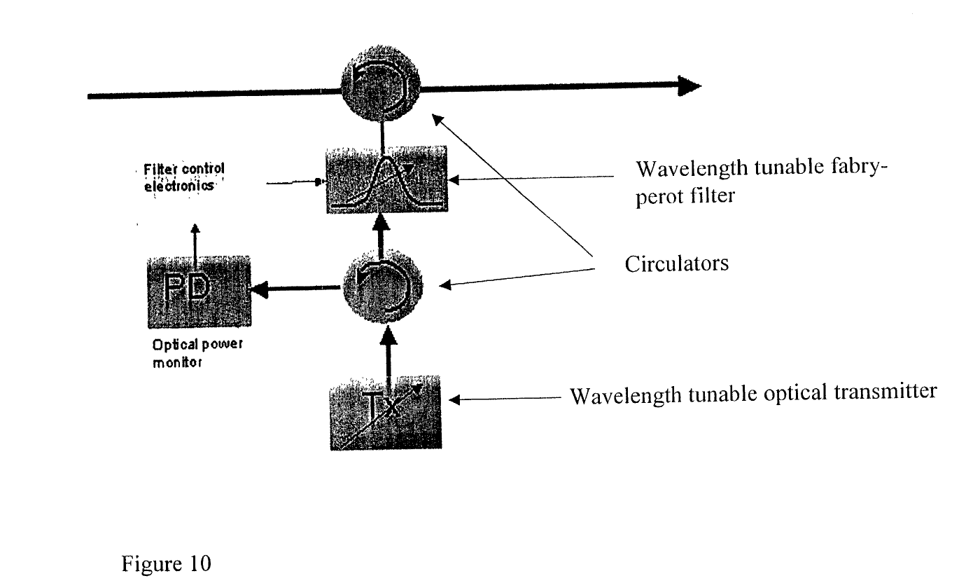

A variety of add elements may be selected for the ADMs provided herein. For example, a conventional broadband optical coupler may be selected as an appropriate wavelength add element. The coupler may couple light signals at any wavelengths coming from a wavelength tunable laser transmitter to be added onto the ring fiber. The particular coupling ratio of the coupler is a design parameter that may be optimized and varies according to particular network applications. For certain preferable embodiments of the invention, it has been observed that coupling ratios in the range of 1:10 and 30:70 are appropriate for most network designs. Alternatively, when the inherent losses associated with directional couplers are not desired, other tunable add elements may be selected. As shown in FIG. 10, relatively low-loss circulators and low-loss tunable filters may be installed in front of a wavelength tunable optical transmitter. An optical signal emitted from the transmitter may pass through a series of circulators and a wavelength tunable Fabry-Perot filter prior to being added onto the fiber. The filter may be also connected to filter control electronics which in turn is fed information from an optical power monitor that observes the light signals passing through a circulator adjacent to the transmitter. It shall be understood that one or more suitable add elements know by those in the field may be incorporated into the ADM designs provided herein.

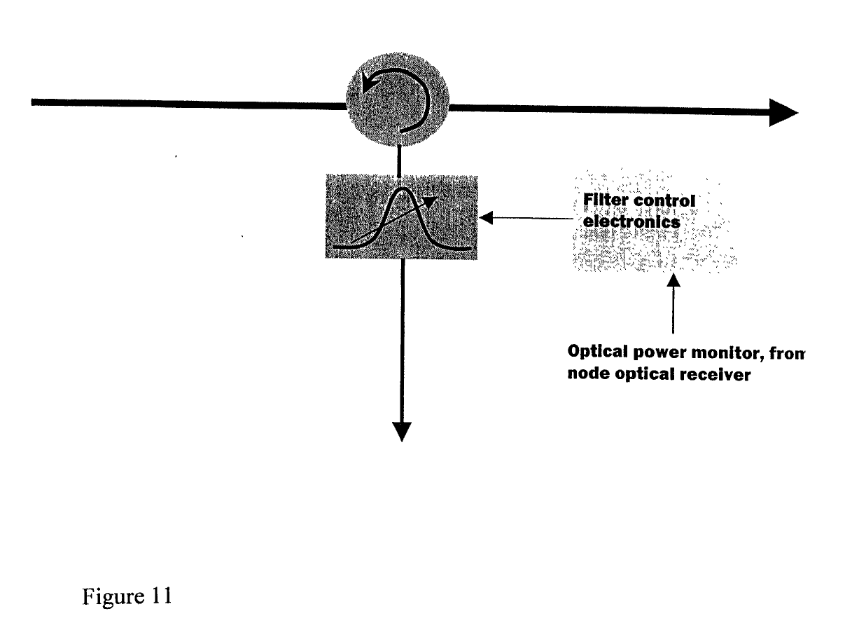

A variety of drop elements may be also selected for the ADMs provided herein in accordance with the invention. For example, as illustrated in FIG. 11, filters may be modified to drop light signals at variable selected wavelengths. One or more of these tunable filters or drop elements may be installed within an ADM and controlled by filter control electronics similar to those described for add elements above, which in turn receives information from power monitors monitoring the light signals at the node. The filter control electronics may further be coupled to or include a node microprocessor that controls the wavelength at which the filter is to receive signals. The control electronics may dither the maximum transmission point of the tunable filter about a setpoint while monitoring an optical power monitor signal from the optical receiver of the node. This allows the filter setpoint to be optimized for maximum transmission using standard control techniques. By providing network nodes with tunable filters and receivers, dynamic assignment of wavelength addresses may be provided in accordance with the reconfigurable lightpath ring architecture herein. Having a tunable wavelength drop element may also minimize or reduce larger inventories of fixed filters or receivers since one component may be selected for various network locations and set to receive signals at certain unique wavelengths as assigned by an NMS. These and other variations to the add/drop elements and ADM componentry may be combined in whole and in part with other aspects of the invention provided herein.

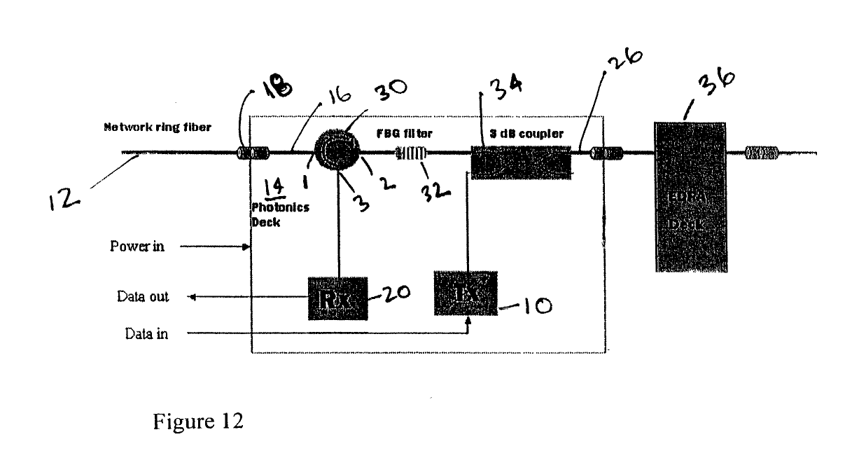

FIG. 12 provides an illustration of an add-drop multiplexer (ADM) that may be installed at the network nodes of the configurable optical networks described herein. Each ADM may include at least one tunable laser transmitter 10 and at least one fixed receiver 20 to receive signals at the designated wavelength for such node. A network ring fiber 12 may be connected to an input 16 of a photonics deck 14 with suitable connectors 18 to receive incoming light transmissions, and an output 26 may be included to mate with the network ring fiber to carry outgoing signals. It shall be noted that optical signals travel on the ring fiber 12 as shown from the left to right direction. An incoming light transmission at all network wavelengths may enter a circulator 30 at port 1, and exit the circulator at ports 2 and 3. From port 3, a signal line may carry intended signals for the particular node which may be dropped and received by the node receiver 20 in the transmission of data. In addition, from port 2, other optical signals passing through the node are transmitted over a line which may further include a fiber Bragg grating (FBG) 32 designed to operate as a bandpass filter in reflection to reflect light at Lambda(k) and transmit light at all other wavelengths through the FBG. The reflected signal at Lambda(k) may re-enter the circulator 30 at port 2, exit the circulator at port 3, and is thereby detected at the receiver 20. The FBG 32 may efficiently drop the signal at Lambda(k) for the node without leaving any significant residual signal. At the same time, signals may be added at the node by receiving data at this site to be distributed out over the network. Optical signals may be transmitted by a tunable laser transmitter 10 at selected wavelengths depending upon the destination of the data. It has been observed that using a FBG 32 with bandpass in transmission may automatically isolate the receiver 20 from backreflections created by the coupler 34. An open circulator may also isolate other elements upstream from the receiver which may cause undesired interference. At the same time, the optical signals passing through the FBG 32 may be combined with other optical signals generated by the transmitter 10 with a directional coupler 34. The coupler 34 or a power splitter/combiner, which may be either wavelengthselective or wavelength-dependent, may also drop off 3 dB of all signals passing through it. This would include all the signals passing through this node and any signals added by the node transmitter 10. Some of the directional couplers selected in the figures herein are described as 2-to-1 (input-to-output ports) 50% couplers (aka a 3 dB coupler). However, the selected coupling length and other parameters affecting the coupling ratio will depend on the particular system implementation and may be modified in accordance with known techniques. For a network that intended to include many network nodes, one of ordinary skill may employ a coupler with perhaps a relatively lower coupling percentage to tap off a relatively smaller portion or fraction of the input signals. It has been observed through analytical optimization that for optical networks without amplification, a preferable coupling ratio of 10% may be selected. Furthermore, amplifiers may be included in the networks provided herein as shown to boost optical signals and compensate for signal loss. An EDFA 36 or other signal amplifiers may be included at various locations in proximity to network nodes as shown to boost the intensity of optical signals carried throughout the fiber optic network.

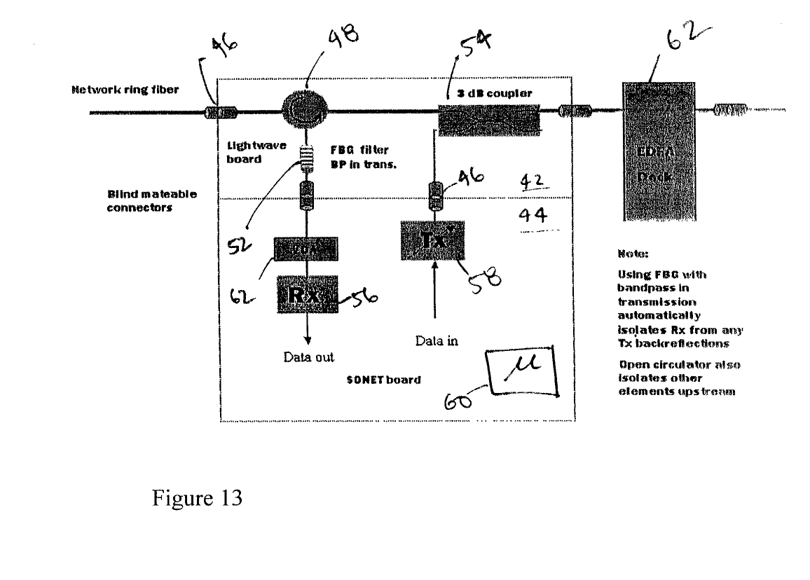

As explained herein, a wide variety of circuits may be used with the WDM systems described herein to optically add and drop optical signals. Their basic functions as an ADM include extracting and dropping a signal from transmitted optical transmissions, and multiplexing and adding additional signals from that site onto the transmission line with other signals in accordance with established protocols. For example, FIG. 13 illustrates yet another ADM device that may be used in the reconfigurable optical networks herein to assist in providing bandwidth reallocation. The ADM device may include input and outputs in communication with a network ring fiber similar to those already described herein. The ADM shown may consist of a lightwave board 42 and a SONET board 44 which may be connected with blind mateable connectors 46 or otherwise provided as an integrated unit. The lightwave board 42 may house a circulator 48 which splits the optical signals into a FBG filter 52 and a coupler 54. An open three-port circulator may act as an isolator in this embodiment for any laser light that may be backreflected from a downstream component such as the directional coupler or FBG. The FBG filter 52 in the embodiment shown may be configured as bandpass in transmission. The line leading into the FBG filter 52 may be configured to permit light to pass through at a selected wavelength specific for the node. At the same time, light at all other non-transmissive wavelengths will reflect away from the receiver 56. The light signals specific for the node may be directed from the lightwave board 42 of the device into the SONET board portion 44 where a fixed node receiver 56 is housed. At the same time, the SONET board 44 may receive incoming data from the node to be delivered as optical signals onto the network. A tunable transmitter 58 in the ADM may accept this information and translate them into multiplexed optical signals. These added signals may be combined with other optical signals passing through the ADM by a 3 dB coupler 54 or other suitable signal combiner. An on-board computer or microprocessor 60 in communication with a NMS computer or network may be coupled to and control the transmitter, receiver and any other ADM component. As with other two-to-one couplers illustrated herein, any other signal combining device or component may be selected with an appropriate number of ports. Furthermore, an optimum coupling ratio may be selected which may depend upon whether the network node also supports amplification which may be provided by an EDFA 62. As is known in the field, a 3 dB coupler provides a 50:50 coupling ratio wherein the strength of a signal passing there though is reduced by half or fifty percent. In certain applications described herein, it may be preferable to select other coupling ratios such as a 10:90 ratio or any other ratio in accordance with the invention. In addition, a VOA component 62 may be installed in front of the receiver 56 as shown and outgoing signals from the ADM device may be thereafter amplified with an EDFA deck 62 positioned in a relatively adjacent position on the fiber network. While the VOA 62 shown is positioned in proximity to the receiver 56, it shall be understood that this component may be also installed at other locations throughout an ADM or in proximity thereto. VOAs may be positioned for example in front of the transmitter unit and/or the receiver unit. It shall be further understood that other optical network protocols may be selected for the invention other than SONET as described herein to provide reconfigurable lightpath rings.

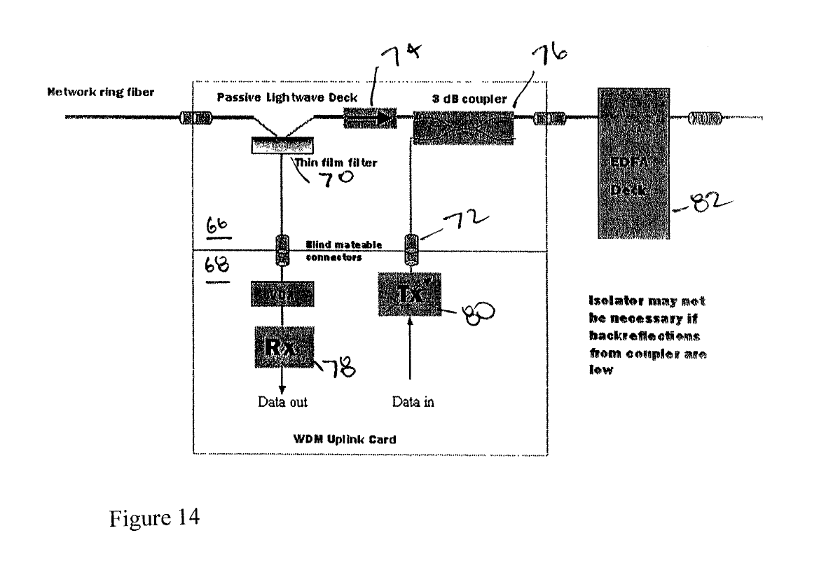

As shown in FIG. 14, there are relatively low-cost approaches that may be adopted herein to provide network nodes with fixed receivers and tunable transmitters. An ADM device may be modified to include a drop element such as a passive lightwave deck 66 that is connected to a WDM uplink card 68 with blind mateable connectors 72. As with other ADM devices described herein, the boards and cards may be integrally formed or otherwise sectioned to hold optical componentry. The lightwave deck 66 illustrated herein however may include a 3-port thin-film filter 70 configured for receiving optical signals at a predetermined wavelength. Other ported thin-film filters may be also selected and substituted for a circulator/FBG configuration also described herein. In addition, an isolator 74 may be selected and positioned in between the filter 70 and a coupler 76 to minimize signal degradation from unwanted optical backreflections from the coupler. It should be understood that for certain applications where backreflections from the coupler (or any other downstream components) are relatively low, it may be unnecessary to include an isolator as shown. Furthermore, the WDM uplink card 68 as shown may include a receiver 78 set to receive light signals at a fixed wavelength that is specific for a particular site or node within the network. A tunable transmitter 80 may be also provided to receive incoming data from this node to be added onto the network ring fiber with the coupler 76 as explained previously. A node within the WDM network as shown may be configured so that signals arriving at a pre-assigned wavelength drop passes through a thin-film filter 70 in order to drop signals that are specific for that node. Meanwhile, other light signals continue on through to the coupler 76 where they are combined with any signals being added onto the fiber at the node. For certain configuration, a tunable laser transmitter 80 and coupler 76 may be selected in which signals incurs a 10 dB loss upon coupling to the fiber transport ring, but express traffic passing through the node may only incur a 10% reduction in signal power. Other coupling ratios may be selected as described herein according to particular applications and intended results. Additionally, at some point along the network ring fiber after the wavelength drop, an EDFA 82 may be added to boost output signals to be transmitted further in the network. The order of sequence for the filter, the amplifier and the coupler as shown may be also reversed or rearranged in accordance with the invention. For example, at nodes that may include an EDFA, incoming light may be amplified before upon entering the wavelength drop and then pass through the coupler before entering the filter. An amplifier may be also positioned between a filter and coupler also. These and other modification to the invention may be carried out when implementing and carrying out the invention set forth herein.

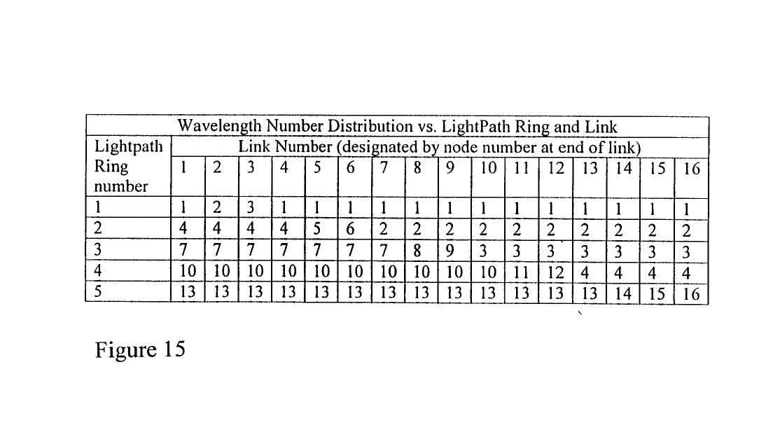

Another aspect or variation of the invention provides configurable optical networks with lightpath rings that may be composed of optical links having repeating or re-usable wavelengths. The aforementioned wavelength usage tables generally described networks that were configured such that no optical wavelengths were reused within the different lightpath rings. For some applications, this may not be an efficient use of available bandwidth resources, particularly in those systems where available channels in the optical frequency spectrum is relatively scarce. There may be also savings in infrastructure costs and maintaining fewer network nodes having fixed receivers or other components which operate within a limited number of available wavelengths. Some embodiments of the invention therefore include the formation of lightpath rings with light signals having the same wavelength within different rings. For example, FIG. 15 provides a ring formation table with wavelength re-use for an optical network that may be dynamically reconfigured depending on bandwidth demand and allocation. For illustrative purposes again there are five lightpath rings described while it is understood that more rings or communication channels may be formed depending upon various parameters including the desired bandwidth and number of network nodes. By re-using some of the same wavelengths, as illustrated in FIG. 15, the available wavelength spectrum may be at times more efficiently utilized. The number of selected wavelengths and the frequency of their re-use may be modified in accordance with the invention. For example, with respect to Lightpath Ring A, only three different wavelengths (Lambda 1-3) are used for the three defined nodes in the ring (Nodes 1-3). The transmitter at Node 1 transmits signals at Lambda 2 which is received by Node 2, and in turn Node 2 is configured to transmit signals at Lambda 3 to be received by Node 3. The transmitted signal by Node 3 at wavelength Lambda 1 in turn “expresses” through all of the intervening nodes in the network until it is received at its intended Node 1 within the lightpath ring. Since there are three nodes within defined Lightpath Ring A, there would be generally more bandwidth available to these network or CPE nodes than a ring with more member nodes. With respect to Lightpath Ring B, there are four member nodes within this defined ring: Node 4 which receives signals from the MNC at Lambda 4; Node 5 which receives at Lambda 5 from Node 4; Node 6 which receives at Lambda 6 from Node 5; and the MNC which receives at Lambda 2.

As shown in FIG. 15, wavelengths may be repeated along different rows in more than one lightpath ring to provide re-use of that particular wavelength resource. Wavelength Lambda 2 is used in both Lightpath Rings A and B. Lambda 3 is similarly re-used in Lightpath Rings A and C, and Lambda 4 is reused in Lightpath Rings B and D. Within remaining Lightpath Rings C through E, there are again four nodes assigned to each ring. But the ring memberships and corresponding wavelength look-up table may be repeatedly altered for each ring to include two or more network nodes depending on established provisioning parameters. In comparison to tables described previously for networks that did not re-use wavelengths, FIG. 15 illustrates another aspect of the invention that provides efficient use or reuse of wavelengths within a finite wavelength spectrum. A number of different wavelengths may be thus selected for use in each ring regardless of whether that wavelength has been used in other lightpath rings. In accordance with the invention, the total number of lightpath rings and the number of members therein may be altered by selected network provisioning systems. The number of nodes and optical links may be also varied to provide dynamic bandwidth provisioning at various network locations. It should be noted that while this wavelength re-use may render applicable reconfiguration algorithms for bandwidth provisioning relatively more complicated, it may provide more efficient use of the available wavelength spectrum. Furthermore, it has been observed that wavelength re-use within optical networks often give rise to coherent crosstalk impairments. Under such circumstances, other embodiments of the invention described herein which do not reuse wavelengths may be more applicable to alleviate or minimize the impact of these and other undesirable effects. These and other variations to the lightpath ring formation described herein may be implemented by those of ordinary skill in accordance with established network parameters.

While the invention has been described with reference to the aforementioned specification, the descriptions and illustrations of the preferred embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention, as well as other variations of the invention, will be apparent to a person skilled in the art upon reference to the present disclosure. It is therefore contemplated that the appended claims shall cover any such modifications, variations or equivalents of the described embodiments as falling within the true spirit and scope of the invention.

What is claimed is:

1. A method for providing bandwidth provisioning within a wavelength division multiplexing (WDM) optical network comprising the following steps of:
selecting a WDM optical network having a plurality of network nodes wherein each node includes a receiver (Rx) configured to receive optical signals at a predetermined wavelength specific for that node and a tunable transmitter (Tx) configured to transmit optical signals at variable wavelengths;
selecting a network management system that is in communication with each network node for instructing the node to transmit an optical signal at a predefined wavelength; and
forming at least one defined continuous lightpath ring within the network having provisioned bandwidth as between a plurality of network nodes for transmission of an optical communication signal by directing the tunable transmitter (Tx) at each network node within the lightpath ring upon command by the network management system to transmit an optical signal at the predefined wavelength corresponding to the receiver (Rx) of only one other node within the lightpath ring to form an optical link therebetween, wherein a plurality of optical links in the aggregate form the lightpath ring to support transmission of the optical signal within the provisioned bandwidth.

2. The method as recited in claim 1 wherein a plurality of lightpath rings are formed within the network each provisioned with allocated bandwidth.

3. The method as recited in claim 2 further comprising at least one metropolitan network center having a cluster of network nodes, and wherein at least two lightpath rings include one node from the cluster of network nodes at the metropolitan network center.

4. The method as recited in claim 1, further comprising the step of:
reforming at least one defined continuous lightpath ring within the network with dynamically reprovisioned bandwidth by altering the number of nodes within the lightpath ring.

5. The method as recited in claim 4 wherein the number of nodes within the lightpath ring is decreased to provide relatively increased reprovisioned bandwidth as between the nodes within the lightpath ring.

6. The method as recited in claim 4 wherein the number of nodes within the lightpath ring is increased to provide relatively decreased reprovisioned bandwidth as between the nodes within the lightpath ring.

7. A method of providing dynamic bandwidth provisioning comprising the following steps of:
selecting a wavelength division multiplexing (WDM) optical ring network formed with a plurality of network nodes that are configured to transmit optical signals at variable wavelengths and receive optical signals at a predetermined wavelength;
selecting a network management system computer in communication with the plurality of network nodes to direct the wavelengths at which each node transmits and receives;
forming a defined lightpath ring within the network by selecting a first plurality of network nodes to provide a channel to support the optical transmission of a communication signal therebetween having a first bandwidth allocation, wherein each network node within the first plurality of network nodes is instructed upon command by the network management system to transmit an optical signal at a predetermined wavelength that is to be received by only one other network node within the first plurality of network nodes to form a first series of optical links therebetween which in the aggregate form the lightpath ring; and
reforming the lightpath ring upon command by the network management system by altering the number of network nodes within the first plurality of network nodes to define a second plurality of network nodes to provide the channel with a second bandwidth allocation, wherein each network node within the second plurality of network nodes is instructed upon command by the network management system to transmit an optical signal at a predetermined wavelength that is to be received by only one other network node within the second plurality of network nodes to form a second series of optical links therebetween which in the aggregate reforms the lightpath ring.

8. A reconfigurable optical network with dynamic bandwidth allocation comprising:
a plurality of network nodes wherein each node includes a receiver (Rx) configured to receive optical signals at a predetermined wavelength specific for such node and a tunable transmitter (Tx) configured to transmit optical signals at variable wavelengths; and
a network management system computer for provisioning bandwidth that is in communication with each network node across a control network, wherein the management system computer forms at least one reconfigurable lightpath ring as between a plurality of nodes within the network to provide an optical communication channel having a provisioned bandwidth by directing the tunable transmitter (Tx) at each network node within the lightpath ring to transmit an optical signal at the predefined wavelength corresponding to the receiver (Rx) of only one other node within the lightpath ring to form an optical link therebetween, wherein a plurality of optical links in the aggregate form the reconfigurable lightpath ring to support transmission of the optical signal at the provisioned bandwidth.

9. The optical network as recited in claim 8 wherein the network management system includes a memory for storing the wavelength assignments for each optical link within each configurable lightpath ring.

10. The optical network as recited in claim 8 wherein the plurality of nodes within the configurable lightpath ring is decreased to increase the provisioned bandwidth as between the nodes within the lightpath ring.

11. The optical network as recited in claim 8 wherein the plurality of nodes within the configurable lightpath ring is increased to decrease the provisioned bandwidth as between the nodes within the lightpath ring.
